(19) United States
(12) Patent Application Publication
(10) Pub. No.: US 2009/0192895 A1
(43) Pub. Date: Jul. 30, 2009

(54) METHOD AND A SYSTEM FOR MANAGING NETWORK MARKETING USING HIERARCHICAL SOCIAL NETWORKING WEBSITE

(76) Inventors: Shai Gerichter, Shoam (IL); Einat Gerichter, Shoam (IL)

Correspondence Address: The Law Office of Michael E. Kondoudis, PC, 888 16th Street, N.W., Suite 800, Washington, DC, 20006, US

(21) Appl. No.: 12/353,924

(22) Filed: Jan. 14, 2009

Related U.S. Application Data
(60) Provisional application No. 61/006,690, filed on Jan. 28, 2008.

(51) Int. Cl. G06Q 30/00; G06Q 99/00

(52) U.S. Cl. 705/14; 705/26

(57) ABSTRACT

A computerized method of the establishing and managing of a hierarchical social network directed at the distributing of services using a network marketing module through a web based application. The computerized method may include: a) registering as an expert, mediator, customer and the like; b) upgrading user capabilities by becoming a community manager; c) distributing services to community members directly, or through a mediator; and d) managing a commission archives

### CROSS REFERENCE TO RELATED APPLICATION

This application claims the benefit of U.S. Provisional Patent Application 61/006,690 filed on Jan. 28, 2008, which is incorporated herein by reference.

### BACKGROUND

1. Technical Field

The present invention relates to the field of marketing systems and methods. More specifically, the present invention relates to the field of software based network marketing.

2. Discussion of Related Art

Social networks are becoming evermore common and versatile. Social networks server their member in versatile areas and activities, and some contain electronical communication among member. Additionally, evermore services are offered over the web, with various content and business models.

### BRIEF SUMMARY

Embodiments of the present invention provide a computerized method and system that supports the network marketing of varied services.

Accordingly, according to an aspect of the present invention, there is provided a software based Hierarchical Social Networking Module (HSNM). The HSNM enables one or more users to create and participate in a social network wherein a parent-son relation may be defined.

According to another aspect of the present invention, there is provided a hierarchical social network may be built. The social network may include the following user roles: A customer, an expert, a mediator and the like. Each of the users may play in various roles, such as, for example, being both an expert and a customer. In addition, any of the users in the system may also play the role of a community manager. A community may consist of various types of users, grouped together to one community, based on some common denominator. A community manager may add new applicants to his community, may remove users from the community and the like. The community manager may also supply various types of services to community members, and charge a commission for each of the services.

According to still another aspect of the present invention, there is provided a software based Service Module (SM) is presented. The SM enables one or more users to supply varied services to other system users, and the managing of commission transactions related to the services.

In embodiments, services supplied though the system, may include the sending and receiving of electronic documents, the conducting of an online discussion using messaging services and the like. Electronic documents may include textual based documents; Graphical based documents; video and audio files; presentations; graphs; diagrams; pictures and the like. Electronic documents may be sent periodically on a regular basis, or once for each specific request. The electronic documents may be sent through standard internet messaging devices, such as: Email; Messenger; VOIP and the like. In embodiments, services supplied though the system, may include the generating and managing of credit and debit notes consisting of one or more commission charges. The system enables the generating of credit and debit notes in various scenarios, such as: for a service given by an expert to one or more members of the community; for a service given by a member in a community to another member in the same or different community; for a service given by a mediator and the like. The system may generate multiple credit and debit notes for the same transaction, reflecting multiple commission that may be charged by multiple users for the same job.

### BRIEF DESCRIPTION OF THE DRAWINGS

The present invention will be more readily understood from the detailed description of embodiments thereof made in conjunction with the accompanying drawings of which:

FIG. 1 is a schematic use case diagram illustrating system functionality, according to some embodiments of the invention;

FIG. 2 is a flow chart illustrating the managing of a user profile implemented by the system of FIG. 1, according to some embodiments of the invention;

FIG. 3 is a flow chart illustrating the ordering of a service by a registered customer implemented by the system of FIG. 1, according to some embodiments of the invention;

FIG. 4 is a flow chart illustrating the mediation of a service between expert and customer by a registered mediator implemented by the system of FIG. 1, according to some embodiments of the invention;

FIG. 5 is a flow chart illustrating the supplying of a service to one or more customers by an expert implemented by the system of FIG. 1, according to some embodiments of the invention;

FIG. 6 is a flow chart of an example for the registering of an expert, illustrating the system process given in FIG. 2, according to some embodiments of the invention;

FIG. 7 is a flow chart of an example for the ordering of a service by a registered customer, illustrating the system process given in FIG. 3, according to some embodiments of the invention;

FIG. 8 is an example for the hierarchical diagram of a social network implemented by the system of FIG. 1, according to some embodiments of the invention;

FIG. 9 is a flow chart of an example for the mediating of a service through a registered mediator, illustrating the system process given in FIG. 4, according to some embodiments of the invention; and

FIG. 10 is a flow chart of an example for the supplying of a service to one or more customers, illustrating the system process given in FIG. 5, according to some embodiments of the invention.

### DETAILED DESCRIPTION

The present invention relates to a novel system and method for the establishing and managing of hierarchical social network directed at the distributing of services using a network marketing business module, thorough a web based software application.

It should be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It should be understood that the phraseology and terminology employed herein is not to be construed as limiting and is for descriptive purpose only.

The principles and uses of the teachings of the present invention may be better understood with reference to the accompanying description, figures and examples.

It should be understood that the details set forth herein do not construe a limitation to an application of the invention. Furthermore, it should be understood that the invention can be carried out or practiced in various ways and that the invention can be implemented in embodiments other than the ones outlined in the description below.

It should be understood that the terms “including”, “comprising”, “consisting” and grammatical variants thereof do not preclude the addition of one or more components, features, steps, integers or groups thereof and that the terms are not to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and characteristics of the claimed composition, device or method.

If the specification or claims refer to “an additional” element, that does not preclude there being more than one of the additional element.

It should be understood that where the claims or specification refer to “a” or “an” element, such reference is not to be construed as there being only one of that element.

It should be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein ought to be commonly understood as by one of ordinary skill in the art to which the invention belongs, unless otherwise defined.

The present invention can be implemented in the testing or practice with methods and materials equivalent or similar to those described herein.

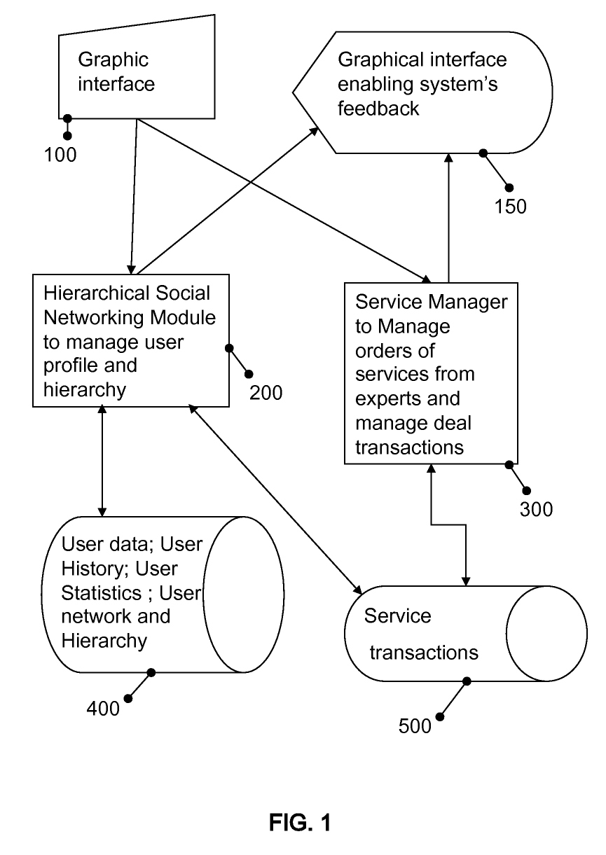

Reference is now made to FIG. 1, which schematically illustrates the system main modules, according to an embodiment of the invention.

According to some embodiments of the invention, system includes the following modules: A graphic interface (100,150); a Hierarchical Social Networking Module (HSNM) (200) enabling the establishing and managing of hierarchical social network; a Service Manager (SM) (300) enabling the managing of services and commission transactions; User data manager (400) storing user information such as user data, user history, user statistics, network and hierarchical user relations; and a Service transactions manager (500) storing ordered and supplied services followed by one or more commissions for each of the supplied services.

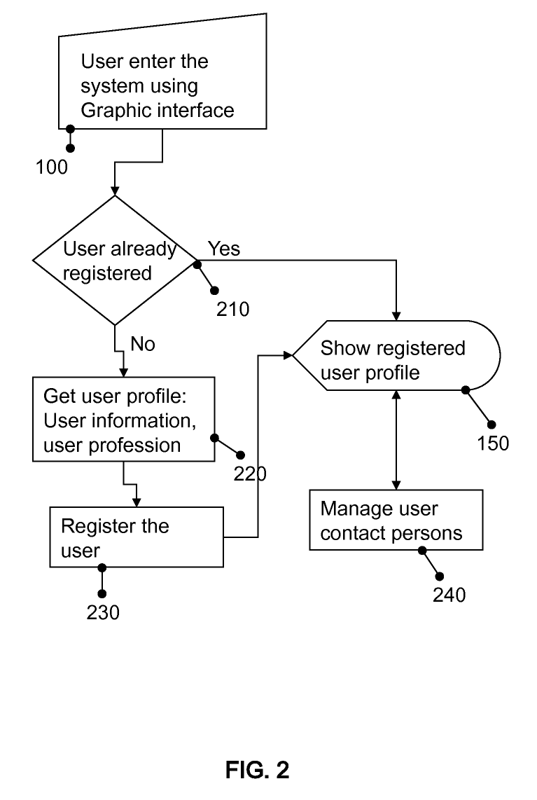

Additional reference is now made to the flow chart in FIG. 2, which schematically illustrates the managing of a user profile. A user may login to the system through the GUI (100). If the user has never registered before (210) he may establish his own personal profile (220) and register as a new user (230). Once a user is registered, he may view and edit his own profile (150) and manage his contact list (240). A system user may be one of the following types: A regular customer that may be interested in any of the services supplied by other registered users; an expert user, which may supply services or order services from other users; and a mediator, which may mediate between two or more users, interested in service exchange. The system enables a registered user to play different roles at the same time. For example, an expert can also be a customer, and both supply services and request for services from other registered users. In addition, any registered user may also become a community manager. A community manager may conduct additional operations other than those enabled by a normal registered user. Such operations may include: adding new members to the community; removing members off the community; supplying services on a regular basis to community members; and charging commission for supplied services given by one or more of the community members. Services on a regular basis may include electronic documents and the like. The electronic documents may be any of the following type: textual documents; pictures; movies; presentations and the like. The electronic documents may be sent through standard internet messaging devices, such as: Email; Messenger; VOIP and the like.

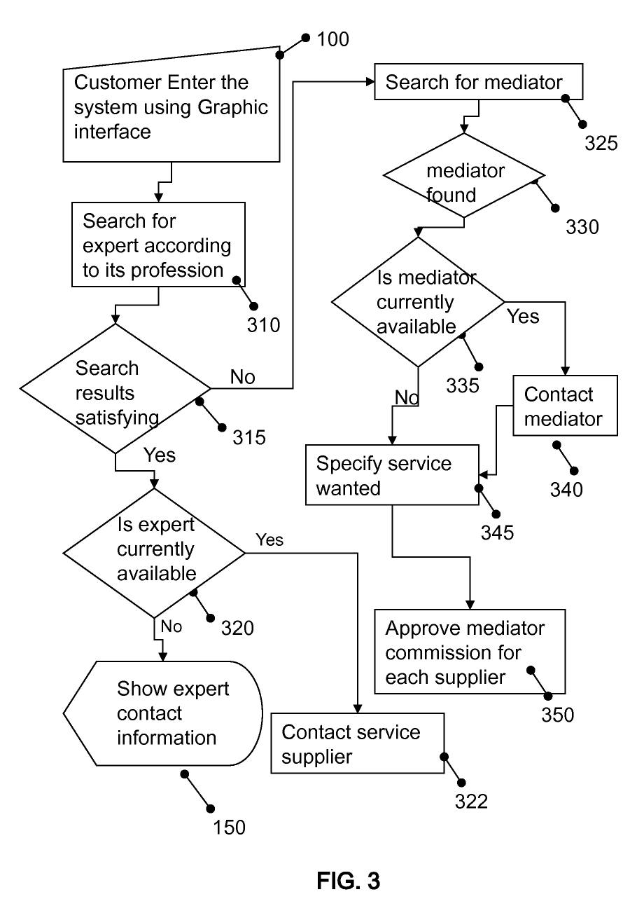

Additional reference is now made to the flow chart in FIG. 3, which schematically illustrates the ordering of a service by a registered customer. A registered customer may order one or more services from other registered users. A registered user ordering such service can be regarded as a customer. A service ordered from a certain registered user is regarded as an expert. Once the customer is logged in through the GUI (100) he may search for a specific type of expert, that may deliver the service needed (310). If the search results are satisfying (315), the customer may start ordering the service from the specific expert found. Assuming the expert was found, the customer may start an online conversation with him, using the system messaging device, in order to find out whether or not he can deliver the service needed. If the expert is online (320) he may contact him directly through the messaging device and discuss deal terms (322). If expert is not online (320), the customer may save expert information supplied by the system (150) for future use. Assuming the expert was not found, the customer may look for a mediator (325). A mediator is also a registered user, who may hold large amount of contacts, and who may be familiar with different type of recommended experts. If a mediator was found (330), the customer may find out if he is available for an online discussion (335). If mediator is online, the customer may discuss the type of service needed and the deal terms, though the messaging device (340). If mediator is not online, the customer may leave a notification (345) specifying the type was service needed and approve the commission that might be charged, based on service supplying (350).

According to some embodiments of the invention, notification may comprise electronic notification comprising at least one of: a textual document; a video signal; and an audio signal.

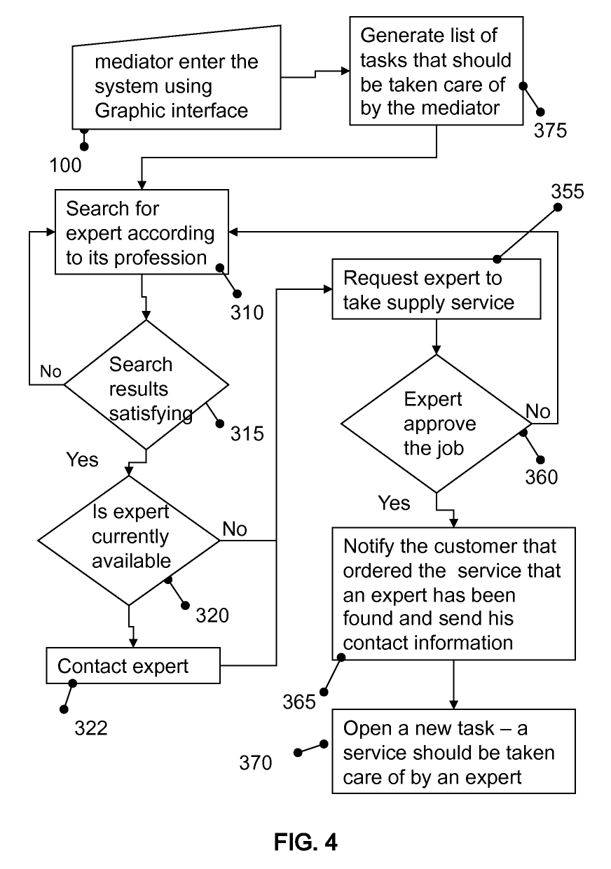

Additional reference is now made to the flow chart in FIG. 4, which schematically illustrates the mediation of a service between expert and customer by a registered mediator. A mediator is a registered user, which may function as mediating entity between two registered users, such as customer and expert. Once the mediator is logged in through the GUI (100), a list of services and experts ordered by one or more customers, may be generated (375). The mediator may select one of the experts needed, and look for him in his contact list, or any list of registered user that can be generated by the system (310). If the search results are satisfying and an expert has been found (315), the mediator may try and start a discussion with him, regarding the service in hand. If the expert is online (320), the mediator may start the discussion, using the messaging service (322) and request the expert to supply the service (355). If expert is not online, mediator may create a request for a service from selected expert (355). Assuming the expert approves the job (360), a notification message will be generated to the customer ordering the service, that an expert has been found (365). The notification (365) may include expert's information such as field of expertise, contact information and the like. Furthermore, the system may generate a notification to the expert as well, specifying the type of service that should be supplied and other information, originally supplied by the customer (370).

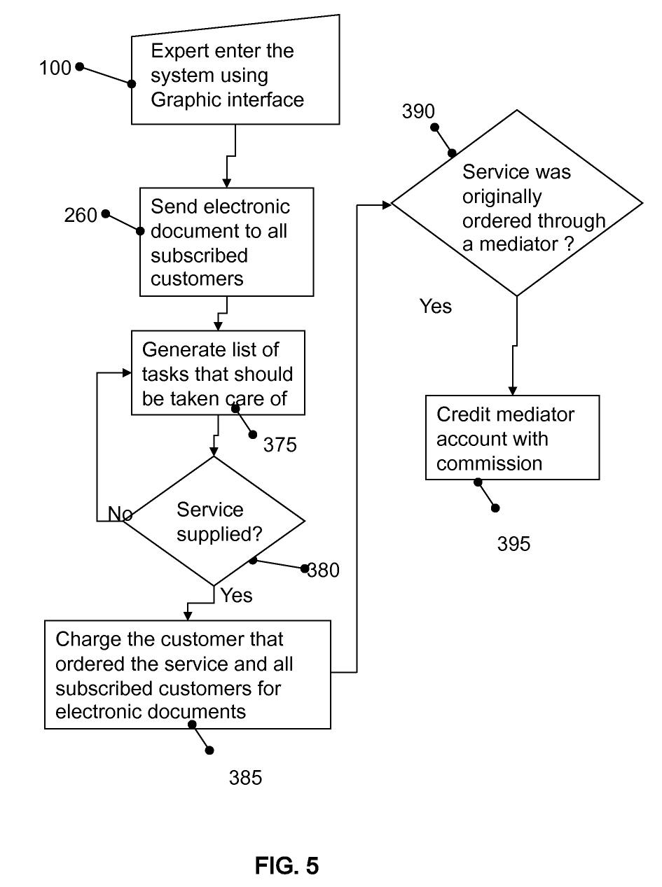

Additional reference is now made to the flow chart in FIG. 5, which schematically illustrates the supplying of a service to one or more customers by an expert. Once the expert is logged in through the GUI (100), electronic documents may be sent to one or more subscribed customers (260). Expert may prepare the electronic documents, as part of a service provided to the subscribed customers on a regular basis. Expert may also supply service requested by customers. The requested services may be compiled to a list of tasks, waiting to be handled by the expert (375). Once a service was supplied and a task is completed (380), the system may generate a debit note reflecting customer's commission charge for the service (385). If a service was mediated through a mediator, the mediator account will be credited with the commission.

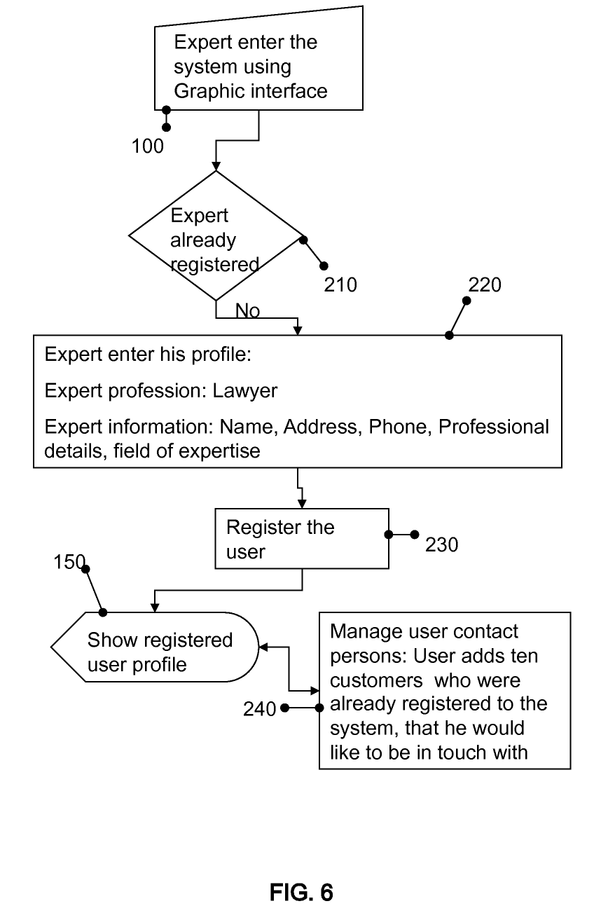

Additional reference is now made to the flow chart in FIG. 6, which schematically illustrates an example for the managing of a user profile illustrated in FIG. 2. In our example a professional lawyer is registering to the system as an expert for the first time, through GUI (100). Since the user is registering for the first time, he is still not found in the user list (210). In order to register, the user may enter his profile, such as, his name, address, field of expertise and the like (220). Once profile building is completed, the system may register the new user (230), his profile is added to the user data and the profile is presented for approval using GUI (150). Once the user is registered, he may add other registered users to his contact list, and build his own social network (240).

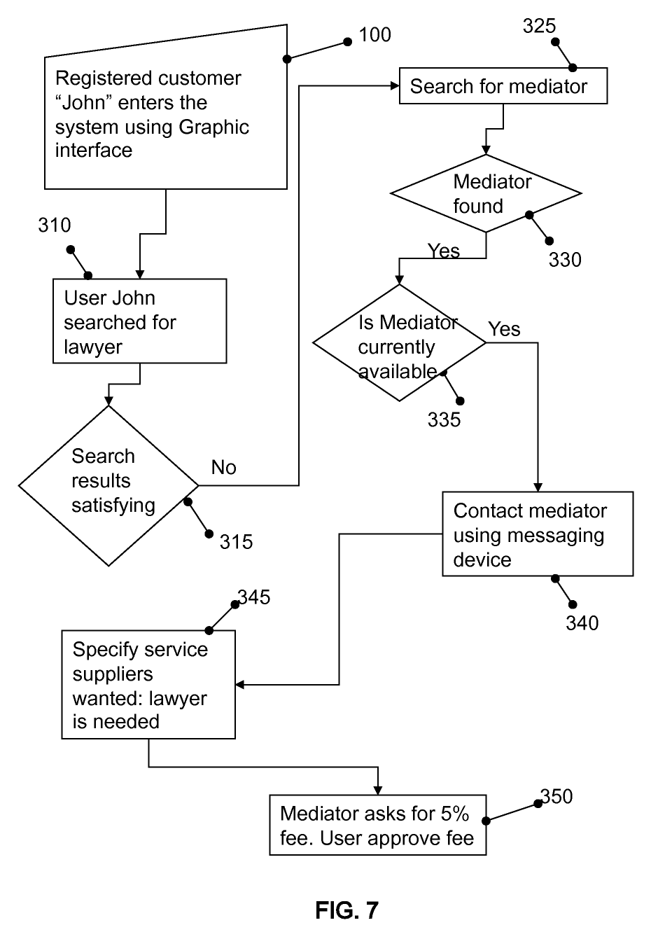

Additional reference is now made to the flow chart in FIG. 7, which schematically illustrates an example for the ordering of a service by a registered customer illustrated in FIG. 3. In our example, a registered user, named John logs in to the system, using the GUI (100). The registered user plays a customer role, and looks for a lawyer (310). In our example, the customer John could not find the right lawyer for the job (315), and a mediator is requested (325). Once a mediator is found (330) and appears to be available for an online discussion (335), the customer requests his services through a messaging device (340). The customer may then specify the exact type of services he may need (345) and agree for a payment of 5% commission, if the mediator finds the right lawyer (350).

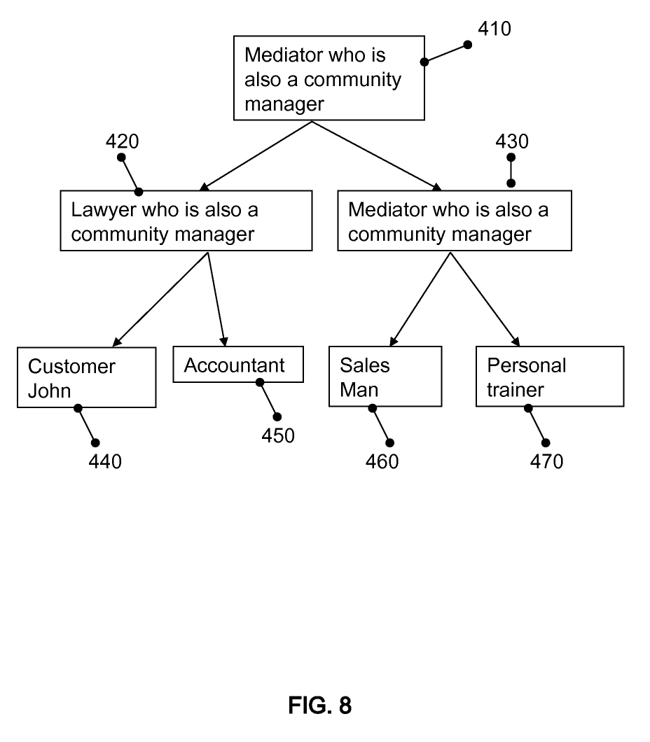

Additional reference is now made to the diagram in FIG. 8, which schematically illustrates an example for hierarchical social network that may be created in the system. The entities in the diagram are all registered users that may play a specific role in the system. In our example we can see the customer John (440), an accountant expert user (450), a sales man (460) and a personal trainer (470). Both John (440) and the accountant (450) are part of a community, managed by a community manager expert user, which is also playing a role of a community manager (420). By being a community manager, the lawyer (420) may supply the community any services, on a regular basis, such as electronic documents, and in return, may be paid a pre-defined commission. In our example, there is another community manager, who may also play the role of a mediator (430). Both lawyer (420) and mediator (430) are part of a community as well, who its manager is also a mediator, which plays the additional role of a community manager (410).

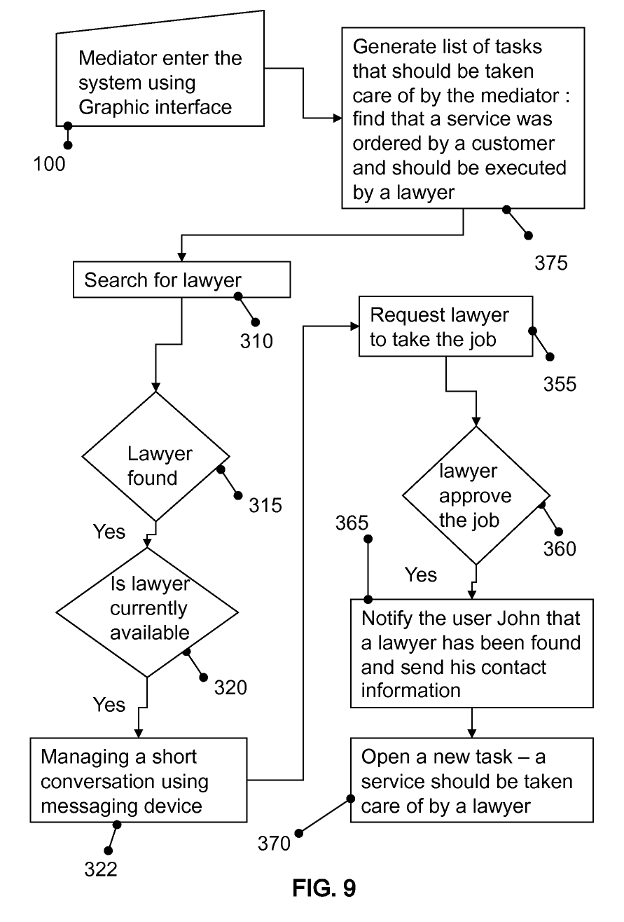

Additional reference is now made to the flow chart in FIG. 9, which schematically illustrates an example for the mediation of a service between expert and customer by a registered mediator pert illustrated in FIG. 4. In our example, a registered user, who is also a mediator, logs in using the GUI (100). Once the mediator is logged in, a list of tasks that the mediator should take care of is generated and viewed. One of the tasks may be, a customer requesting for a special service from a lawyer (310), which was already previously described in FIG. 7. The mediator may than search for a lawyer within his personal social network, or within any list of experts that may be supplied by the system. Once a lawyer is found (315), the mediator would like to discuss the nature of the service that should be supplied. If the lawyer is available (320), an online discussion may take place, using a messaging device (322). The mediator may request the lawyer to take the job (355). If the lawyer approves the job (360), the mediator may than send a notification to the user John, which discloses lawyer contact information (365), and a new task is then opened to the lawyer, consisting of the type of service the customer information (370).

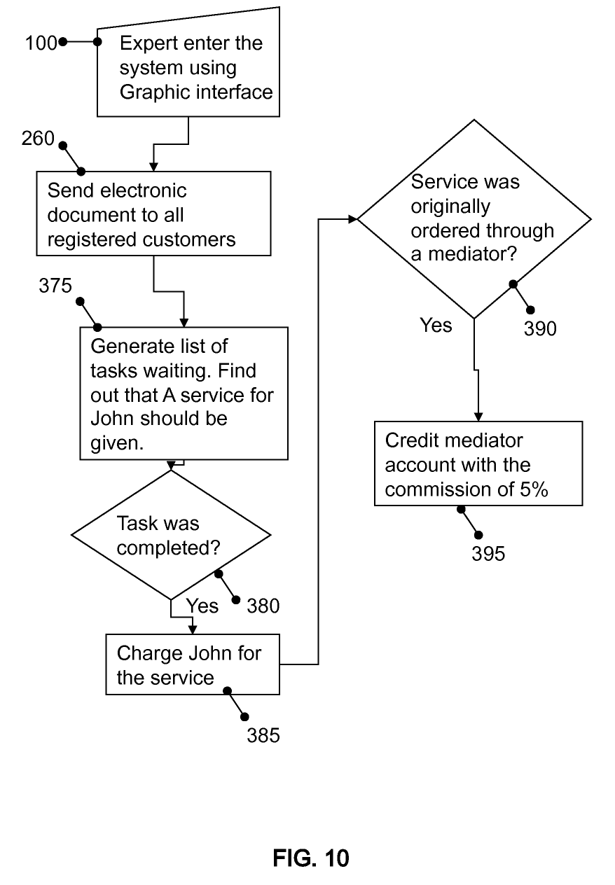

Additional reference is now made to the flow chart in FIG. 10, which schematically illustrates an example for the supplying of a service to one or more customers by an expert illustrated in FIG. 5. As previously described in FIG. 7 and FIG. 9, the lawyer accepted the mediator request to deliver a service to the registered user John and a new task consisting of this service was added to the lawyer's tasks list. In our example, the lawyer logs in using the GUI (100). Once the lawyer enters the system, he may send electronic documents to all his community members (260). He than may ask to present the list of tasks waiting to be done (375). The service requested by John can now be delivered (380) and John account may be charged (385). In our example, the service was requested, through a mediator. Since a mediator has been involved (390) a commission of 5% can be deducted and delivered to the mediator account (395).

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it should be understood that alternatives, modifications, and variations of the present invention are to be construed as being within the scope of the appended claims.

What is claimed is:

1. A computerized method of marketing at least one user service through a hierarchical social networking website, the computerized method comprising:
managing a hierarchical social network website, the hierarchical social network website including adding and managing hierarchical user communities;
managing, generating and transmitting electronic notifications and conducting real time communications between multiple users; and
enabling user service exchange, wherein mediators between users are enabled to charge commission transactions.

2. The method of claim 1, wherein community consists of one or more users grouped together by at least one community manager.

3. The method of claim 2, wherein community further includes one or more communities.

4. The method of claim 1, wherein a user is defined as a customer, the customer is enabled to order of one or more services from other users;

5. The method of claim 1, wherein a user is defined as a mediator that is enabled mediating of one or more services between multiple users and charging commission

6. The method of claim 1, wherein a user is defined as an expert that is enabled to supply of multiple services;

7. The method of claim 1, wherein a user is defined as a customer community manager that is enabled managing of a community services and transactions.

8. The method of claim 1, wherein electronic notification comprises at least one of: a textual document; a video signal; and an audio signal.

9. The method of claim 1, wherein real time communication comprises at least one of: textual based; and VOIP.

10. The method of claim 1, wherein user services include the supplying of any type of electronic document to one or more users.

11. The method of claim 1, wherein user services are supplied periodically.

12. The method of claim 1, wherein a commission is charged for any of the services, the charging including the generation of multiple credit and debit notes for at least one transaction.

13. A computerized system for marketing at least one user service through a hierarchical social networking website, the computerized system comprising:
a hierarchical social networking module for managing the hierarchical social network website, the hierarchical network website including adding and managing hierarchical user communities;
a messaging device that manages the generating and transmitting of electronic notifications and conducting real time communications between multiple users; and
a service module that manages user services and commission transactions.
